(19) United States
(12) Patent Application Publication
(10) Pub. No.: US 2008/0093169 A1
(43) Pub. Date: Apr. 24, 2008

(54) Easy climb safety ladder

(76) Inventor: Allen H. Fletchall, Mesa, AZ (US)

Correspondence Address: Allen Herbert Fletchall, 2728 Leisure World, Mesa, AZ, 85206, US

(21) Appl. No.: 11/639,616

(22) Filed: Oct. 18, 2006

(51) Int. Cl. E06C 1/24

(52) U.S. Cl. 182/172

(57) ABSTRACT

This is ladder that is more user friendly than the arts that are on the market today. This is accomplished by moving the legs of the ladders closer together than present day ladders, and by putting a warning bell on the second step from the bottom warning there is another step below before landing on a solid surface. Adjustable legs are a new feature in this new art of modern ladders. This eliminates time spent looking for a block or other object to put under the leg, thus saving time.

Having the steps closer together makes it easier for the elderly and people with shorter legs to ascend and descend the ladder.

### BACK GROUND OF INVENTION

This invention relates to a step ladder with adjustable length legs, in an up or down position that prior arts do not have. And also shelves and storage spaces that prior arts do not have. There are a number of new features that are introduced in this invention that prior arts do not have. Demonstrated in the drawings and words in this back ground of the invention.

### SUMMARY OF INVENTION

This ladder is a more realistic and safer ladder for the user than prior arts because of the new features than the present standard ladder.

### BRIEF DESCRIPTION OF SEVERAL VIEWS OF INVENTION

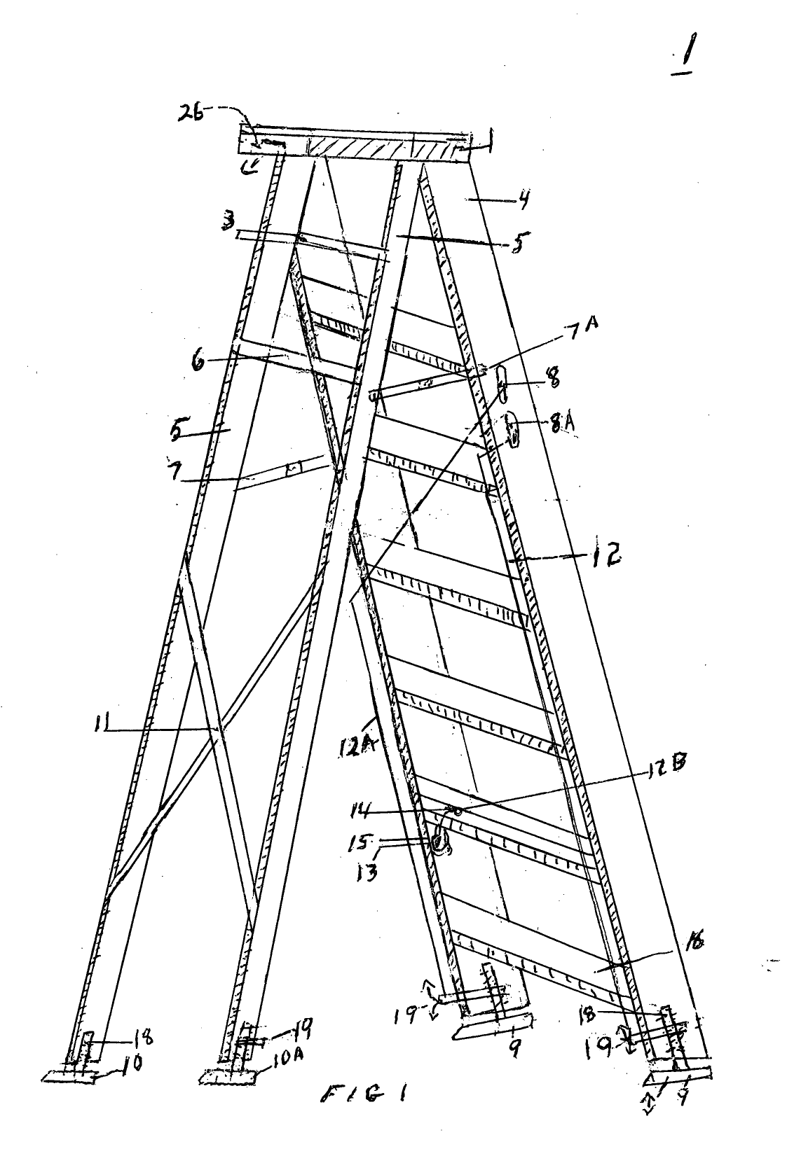

FIG. 1 Displays the new art in it's entirety.

FIG. 1A Shows the right front leg F1 A-4 with adjustments levers F 1A 7-8.

FIG. 2 Depicts step F2-16 front step and assures the ladder will not fold (F2 5) Back leg, FIG. 2 6 with hinged brace F 2-6 that holds the legs apart also. That holds the front leg and back legs apart when the ladder is standing open or in use. Back leg (5) cross brace (11).

FIG. 3 Tells us about the leg adjustment apparatus 10-12-18-19 F3 is the foot, 12 is the adjustment cable, 18 is the flat bar that is the (up-down) holding adjustment 19 is the release lever of 18 that has the up and down movement for the leg that will level the ladder and make it safe to climb.

FIG. 4 Makes for showing the extra conveniences the new art displayed (F 4 1 top of ladder) (F4 2 slide out service) (920 tray tack well) (25 hammer hole) (26 screwdriver holes) (27) (pliers port).

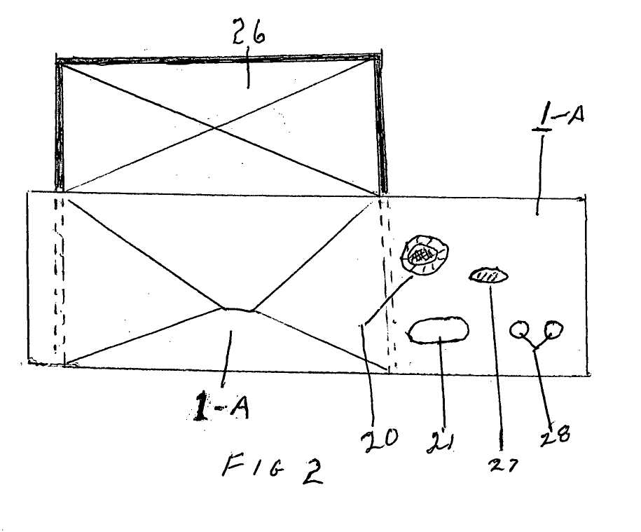

FIG. 5 Displays 3 steps (26-27-28) as they are anchored to the legs (4) with 90 degree angle anchors (25) holding all steps to the leg. Figures, also, shows the safety assemble device number 14 trip wire, when stepped on it pulls 15-to hit 13 the bell which is the alarm bell.

### DETAILED DESCRIPTION OF INVENTION

Page 1 Displays the new art in its entirety, also shows the left and right front legs, and feet. All are very important to the structure.

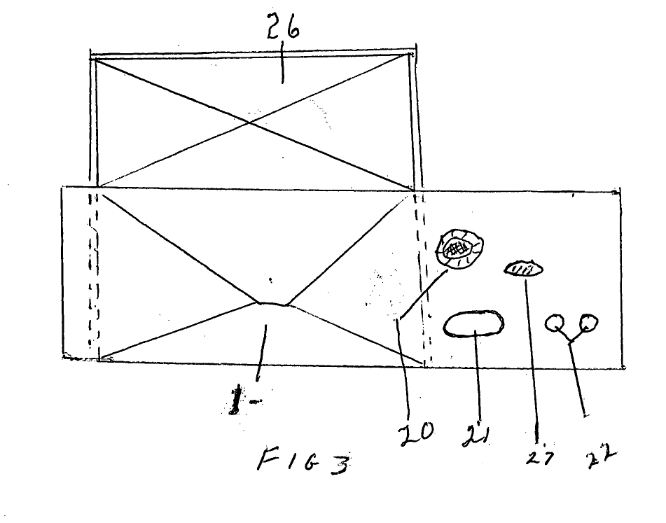

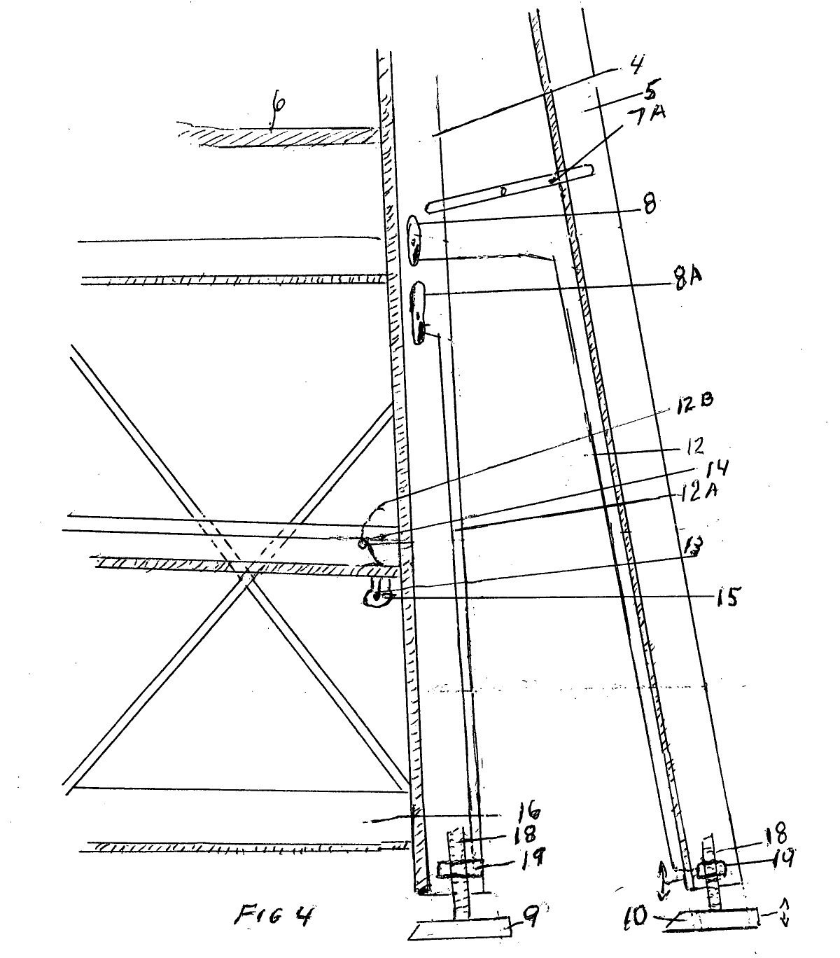

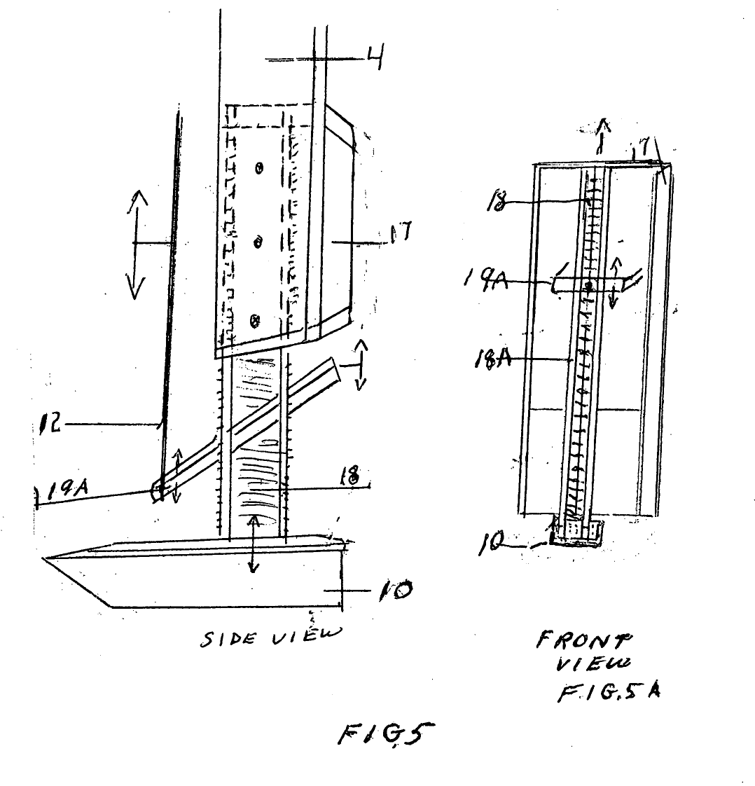

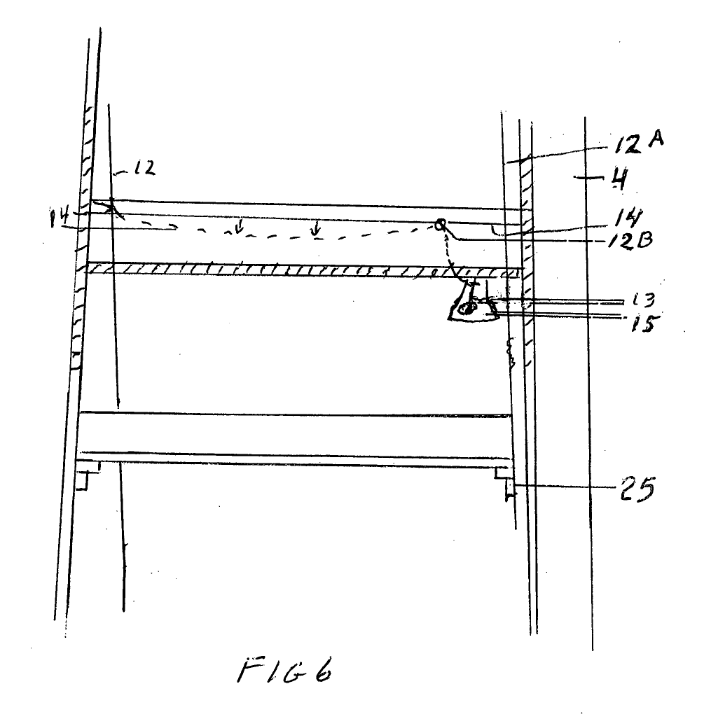

Page 1-A of 6 FIG.-2 shows us the numbered holes in the top accessory step, numbers 20-21-27-28-29 FIG. 2. Also shows the handy slide out Drawer FIG. 2-26.

Page 1 FIG.-8 or 8-A adjustment handles that will release the hold (via) adjustment cable it has on 19-A holding lever, FIG. 1-18. Letting the slide bar slide up or down whichever is appropriate. The slide bar FIG.-18 has the foot attached to the bottom of it, thus lowering or raising the leg to the appropriate length will make the ladder sturdy and safer to climb on. The sequences for lower or raising the length of the legs are as follows. No. 1 pull back on the adjusting handle Page 1 F1-8 or 8A whichever is appropriate, for the front or back adjusting cable. For front leg adjusting, you pull on the lever. (Page 1, FIG. 1 in 8-8A) for the back leg adjustment you pull on the bottom lever 8A, right or left, whichever side needing the adjustment when the levers are pulled, it (via) the adjusting cable releases the hold page 1, FIG. 1-19-A has on 18 the slide bar thus letting the slide bar move up or down as needed to adjust the length of the leg, creating a stable leg and making the ladder safe to climb on. Thus ending the sequence of a leg adjustment.

Page 4 (omitted)

Page 5 FIG.-6 shows the top accessory step with numbered holes for the placement of each accessory tool 20-tack well, 21 hammer hole, 27 plier port, 28 screw driver holes, 26 the handy slide in or out drawer, 29 electric drill hole.

Page 6 FIG. 4 tells us the arrangement of the bottom of the leg—the foot-10 is attached to the vertical slide bar FIG. 3A-18. When the holding lever 19-A is raised up on the front end, it releases its hold on the vertical slide bar, thus letting the vertical slide bar move up or down adjusting the length of the leg creating a stable leg and making the ladder safe to climb on. Page 1 FIG. 1-8 or 8A whichever is appropriate for the front or back on the adjusting lever 19A. That is adjusted and allowing the canal page 18A to be open allowing the slide (notched) bar with the (foot) attached to the slide bar to be adjusted to the proper length. Thus ending the sequence of the leg adjustment for safe climbing.

Page 1-A, FIG. 2. Shows the top accessories step with the numbered holes for tools and tacks, etc. and showing the location for each tool.

Page 2 FIG. 3 Gives us an enlarged view of the midsection of the ladder.

Page 3 shows the exact location of the safety bell on the ladder and the arrangement of it.

Page 3-A of 6—FIGS. 3 and 3-A depicts a larger view of the leveling apparatus.

Page 4 (drawings omitted)

Page 5 of 6 that shows us the location and the arrangement of the accessory tool 20 tack well-21-hammer hole, 27 pliers port, 28 screw driver holes, 26 the handy slide in or out drawer, 29 electric drill hole

1. A safety ladder comprising:
a leg-leveling device having front and rear feet movably supported on respective front and rear legs of the safety ladder;
an adjusting mechanism comprising:
a respective up-down pressure release bar releasably engaging each of the feet;
an adjusting lever supported on the safety ladder and movable between a pressure position and a release position, wherein:
the adjusting lever is connected to one or more of the up-down pressure release bars;
adjusting lever holds one or more of the feet relative to a respective one or more of the legs when the adjusting lever is in a pressure position;
the adjusting lever releases the one or more of the feet relative to the respective one or more of the legs when the adjusting lever is in a release position to permit the feet to move relative to respective legs; and
the legs and respective feet thus form adjustable length legs on the safety ladder;
a safety assembly comprising:
a one more step warning bell connected to a second to lowest step of the ladder;
and a trip cable connected to the bell and the safety ladder adjacent to the second to lowest step by a cable;
a slide out tray on the top step for storing tools;
wherein the stops are fifty percent wider than standard ladder stops, a distance between adjacent ones of the steps is three-quarters of a distance between steps on a standard ladder, and the ladder comprises one or more aluminum, wood, fiberglass and composite material.

2. A safety ladder comprising:
a leg-leveling device having front and rear feet movably supported on respective front and rear legs of the safety ladder;
an adjusting mechanism comprising:
a respective up-down pressure release bar releasably engaging each of the feet;
an adjusting lever supported on the safety ladder and movable between a pressure position and a release position, wherein:
the adjusting lever is connected to one or more of the up-down pressure release bars;
the adjusting lever holds one or more of the feet relative to a respective one or more of the legs when the adjusting lever is in a pressure position;
the adjusting lever releases the one or more of the feet relative to the respective one or more of the legs when the adjusting lever is in a release position to permit the feet to move relative to respective legs; and
the legs and respective feet thus form adjustable length legs on the safety ladder.

3. The safety ladder of claim 3, further comprising a safety assembly having a one more step warning bell connected to a second lowest stop of the ladder.

4. The safety ladder of claim 3, further comprising a trip cable connected to the bell and the safety ladder adjacent to the second to lowest step by a cable.

5. The safety ladder of claim 3, further comprising a slide out tray on the top step for storing tools.

6. The safety ladder of claim 3, wherein the steps are fifty percent wider than standard ladder stops.

7. The safety ladder of claim 3, wherein a distance between adjacent ones of the stops is three-quarters of a distance between steps on a standard ladder.
